(19) United States
(12) Patent Application Publication
(10) Pub. No.: US 2017/0296867 A1
(43) Pub. Date: Oct. 19, 2017

(54) Abdominal Exercise Device with Integrated Back Massager

(71) Applicant: Michael Patrick Doane, Falls Church, VA (US)

(72) Inventor: Michael Patrick Doane, Falls Church, VA (US)

(21) Appl. No.: 15/133,209

(22) Filed: Apr. 19, 2016

(51) Int. Cl. A63B 23/02; A63B 21/02; A63B 21/008; A61H 1/00; A63B 21/00; A63B 21/055

(52) U.S. Cl. CPC A63B 23/0211; A63B 21/0552; A63B 21/023; A63B 21/0087; A61H 1/008; A63B 21/00069; A63B 21/00065; A63B 21/0083

(57) ABSTRACT

An abdominal exercising apparatus should allow the user to strengthen their abdominal and oblique muscles in a comfortable manner. The present invention seeks to strengthen the stomach muscles and do so in a comfortable manner that allows the user of the invention to exercise in an upright seated position, while also providing a massage of the user's back muscles along each side of their spine. The present invention can be used on a bench, chair, couch, or other seating apparatus where it can be used in comfort and while engaged in other passive activities, such as, watching TV. An added benefit of the present invention is that it provides massaging of the muscles on both sides of the user's spine as it is used.

### BACKGROUND OF THE INVENTION

An abdominal exercising apparatus should allow the user to strengthen their abdominal and oblique muscles in a comfortable manner. Sit-up crunches performed on a floor strengthen the abdominal and oblique muscles, but they require the user to lie on a floor, which may be undesirable. The present invention seeks to strengthen the stomach muscles and do so in a comfortable manner that allows the user of the invention to exercise in an upright seated position, while also providing a massage of the user's back muscles along each side of their spine. The present invention can be used on a bench, chair, couch, or other seating apparatus where it can be used in comfort and while engaged in other passive activities, such as, watching TV. An added benefit of the present invention is that it provides massaging of the muscles on both sides of the user's spine as it is used.

### SUMMARY OF THE INVENTION

The present invention relates generally to the field of exercising apparatus for athletic activities. More specifically, the present invention is designed to allow users to strengthen their abdominal and oblique muscles from a seated position. This prevents the user from needing to lie on a floor, as they would when performing sit-up crunches, which keeps the user's clothing cleaner and allows them to exercise in a more comfortable position.

The present invention includes a padded seat for the user to sit upon with the frame of the device positioned behind the user, the device's padded handlebars resting on their shoulders, and the user's hands positioned on each side of their head and gripping the handlebars. While holding onto the handlebars the user bends his or her body forward and moves their head and hands towards their knees in a motion similar to a sit-up crunch. As they are executing each exercise repetition a set of wheels or massaging nubs connected to each side of the device's frame, roll up and down the users back and provide a muscle massaging effect. As the exercise motion is performed, a resistance mechanism located between the device seat and the portion of the frame holding the rollers or massaging nubs extends and as it does it provides resistance. This resistance is provided as the user performs each sit-up crunch motion. The user returns to an upright position after each bending or exercise repetition.

### BRIEF DESCRIPTION OF THE DRAWINGS

FIG. 1—Is a side view from the left of the Abdominal Exercise Device in Use.

FIG. 2—Is an isometric view from the front left side of the Abdominal Exercise Device.

FIG. 3—Is an isometric view from the rear left side of the Abdominal Exercise Device with a Hydraulic Resistance Cylinder.

FIG. 4—Is an isometric view from the rear left side of the Abdominal Exercise Device with an additional resistance band attached between each set of posts extending from the sides of both ends of the resistance device.

FIG. 5—Is a view from the rear of the Abdominal Exercise Device with an additional resistance band attached between each set of posts extending from the sides of both ends of the resistance device.

FIG. 6—Is a view from the rear of the Abdominal Exercise Device with two additional resistance bands attached between each set of posts extending from the sides of both ends of the resistance device.

FIG. 7—Is a left side view close-up of the Abdominal Exercise Device with an integrated single piece flexible spine and hubs with massaging wheels.

FIG. 8—Is an isometric rear left view close-up of the Abdominal Exercise Device with an integrated single piece flexible spine and hubs with rounded massaging nubs in place of massaging wheels.

FIG. 9—Is a left side view close-up of the Abdominal Exercise Device with an integrated single piece flexible spine and hubs with rounded massaging nubs in place of massaging wheels.

### DETAILED DESCRIPTION OF THE INVENTION

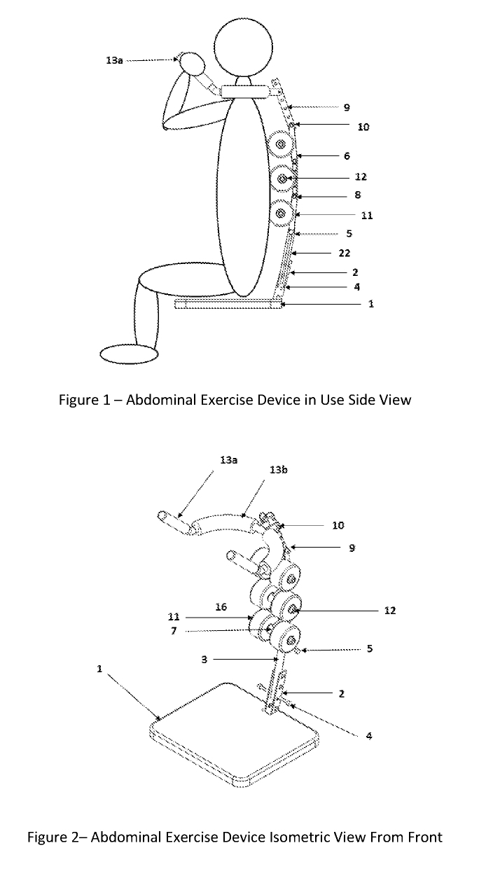

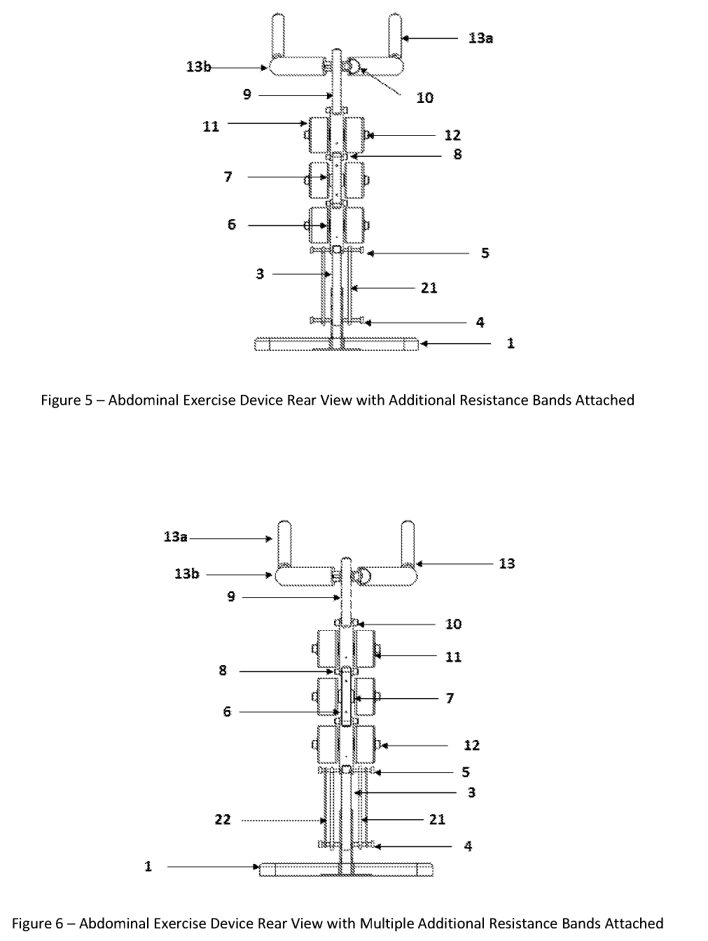

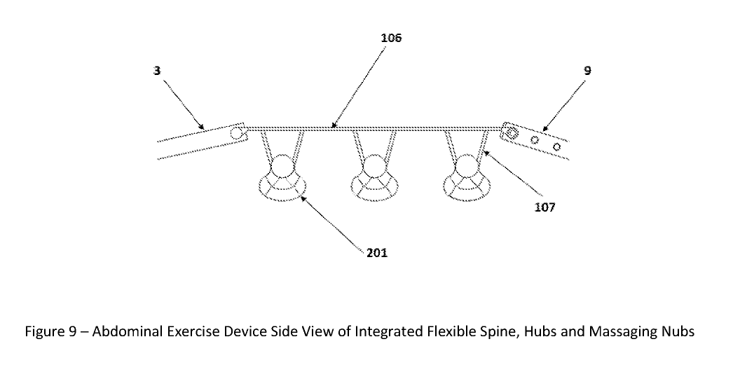

In the present invention a padded base or seat is attached to a resistance device, frame and handlebars that allow a user to target abdominal muscles and oblique muscles when it is used. The invention will now be discussed with reference to FIGS. 1 through 9.

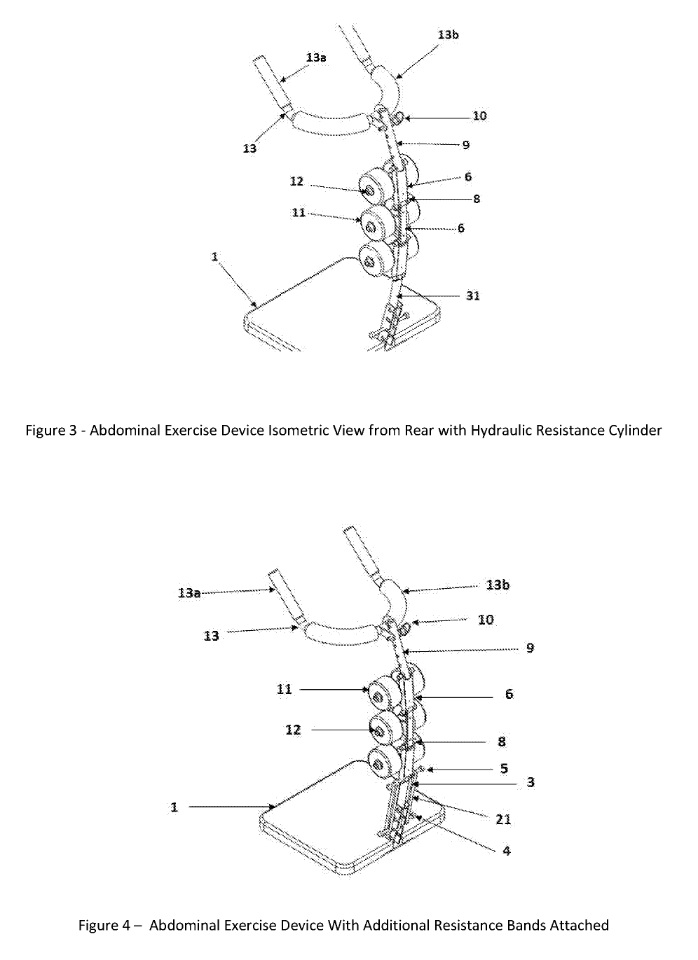

The device includes a padded base or seat, 1, with an adjustable bracket, 2, attached to the seat. A resistance device, 3, or in FIG. 3, 31, attaches to the adjustable bracket at one end and to one of three wheel mounting hub links, 6, that in a preferred embodiment form the central portion of the device frame. It is within the spirit of the invention for there to be as few as two or as many as six mounting hub links, 6, linked together. Each of the mounting hub links, 6, is connected to another mounting hub link with a bolt and nut or a link pin, except for the top hub link which is attached to a length adjustment link, 9, although it is within the spirit of the invention for the top hub link to be attached directly to the handlebars, 13. The mounting hub links, 6, each have wheels, 11, mounted on each side of the hub and rotating on a shaft or bolt, 12. These wheels, 11, serve to roll up and down the muscles on either side of the user's spine as the device is used. In one embodiment, the wheels, 11, are replaced by rounded massaging nubs, 201, which serve the same purpose as the wheels, 11, but may require the user to be wearing a shirt, or other clothing item, so the rounded massaging nubs will slide up and down the user's back more easily as the device is used. In a preferred embodiment the length adjustment link, 9, has multiple holes along its length, although it is within the spirit of the invention for it to be a fixed length with only two holes at each end. The length adjustment link, 9, connects to the padded handlebars 13 using a quick release pin, 10. The handlebars, 13, have padding, 13b, where the handlebars rest against the user's shoulders and neck and hand grips, 13a, at each end for the user to hold onto.

The resistance mechanism, 3 or 31, can be one of a few designs. In each case the resistance mechanism can be elongated and provides resistance to being elongated. The resistance can be provided by an elastic member, such as, a spring-based resistance mechanism, 3, or by pneumatic or hydraulic means with a fixed or adjustable resistance hydraulic or pneumatic actuator, 31. In a preferred embodiment of the invention, the spring is inside of two telescoping tubes and attached to one of the two tubes at each of its ends in a manner that causes the spring or elastic member to stretch when the telescoping tubes are extended. The telescoping tubes provide lateral rigidity that makes it easier for the user to get in and out of the device and it makes it easier to neatly fold the device when it is not in use. Additional resistance mounting posts, 4 and 5, extend from each side of each end of the resistance device, 3, but it is within the spirit of the invention for these mounting posts, 4 and 5, to not be included. In FIGS. 4, 5, and 6 elastic resistance bands, 21 and 22, have been stretched across mounting posts, 4 and 5, on each side of the resistance mechanism, 3. In FIG. 6, multiple elastic resistance bands, 21 and 22, having different elasticity, have been attached across mounting posts, 4 and 5. Elastic resistance bands, 21 and 22, are optional and stretch with the resistance mechanism, 3, as the user performs exercise repetitions on the present invention. The elastic resistance bands provide additional resistance to the user's abdominal and oblique muscles. It is within the spirit of the invention for coiled extension springs to be used in place of the elastic resistance bands.

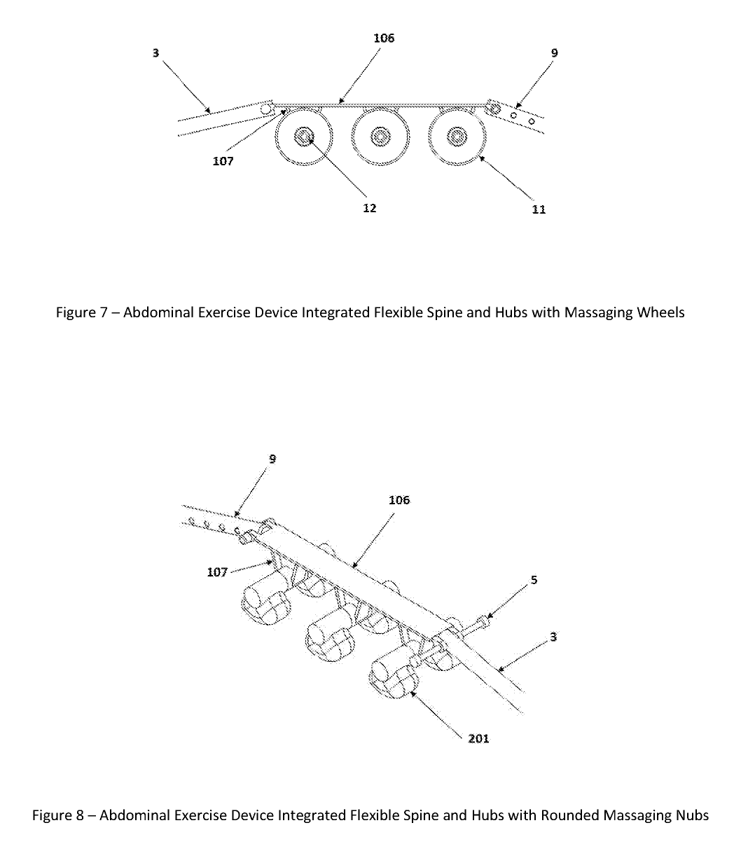

In FIGS. 7, 8, and 9 the three linked together mounting hub links, 6, are replaced by a single integrated flexible spine and hubs, 106, for mounting massaging wheels, 11, or rounded massaging nubs, 201. While the figures depict an integrated spine with three attached hubs, it is within the spirit of the invention for there to be as few as two mounting hubs or as many as six attached to the flexible spine. This integrated design serves the same purpose as mounting hub links, 6, linked together.

FIG. 1 depicts a user in proper form ready to start an abdominal exercise repetition using the present invention. The user is sitting on the exercise device's padded seat, 1, with the device's mounting wheels, 11, resting against the user's back with one of each wheel pair against the muscles on each side of the user's spine and on each side of the mounting hubs, 6, which are positioned directly behind the user's spine. The handlebars', 13, shoulder and neck padding, 13b, are resting near the upper back at the user's neck and on top of the shoulders. The user's hands are on each side of their head and holding handlebar grips, 13a. For a proper height fit the user has attached the resistance device, 3, to the second lowest slot in the adjustable bracket, 2, and the quick release pin, 10, is attached to the handlebars, 13, through the second highest hole on the length adjustment link, 9. To accommodate for users of different heights, the resistance device, 3, can be positioned in other slots in the adjustable bracket, 2, and/or the quick release pin, 10, can be attached to the handlebars through any of the holes on the length adjustment link, 9. It is within the spirit of the invention for the length adjustment link, 9, to be replaced with a fixed length link or for the mounting hub links, 6, or integrated flexible spine and hubs, 106, to be directly attached to the handlebars or for the adjustable bracket, 2, to be replaced with a non-adjustable bracket. While it is preferred to have one or both of these length adjusting parts, it is within the spirit of the invention for the exercise device to be available in different lengths without integrated length adjustment parts.

The user starts each exercise repetition, or sit-up crunch movement, from a seated position as depicted in FIG. 1. The user bends forward moving their hands and head towards their knees and causing the back to curve forward. As each movement is performed the resistance mechanism, 3, stretches and the massaging wheels, 11, roll or in an alternate configuration, the rounded massaging nubs, 201, slide up the user's back. Additional resistance bands, 21 and 22, can be added across resistance mechanism posts, 4 and 5, to increase resistance or the user can adjust the resistance on an adjustable hydraulic or pneumatic actuator serving as the resistance mechanism, 31. The massaging wheels, 11, or rounded massaging nubs, 201, and the hubs to which they are mounted are designed so the exercise device's bending axis is a minimum of two inches, and in a preferred embodiment three to five inches away from and behind the user's back, which keeps the resistance mechanism, 3 or 31, and the length adjustment link, 9, from touching the user's back during execution of each exercise repetition.

1. An exercise device comprising:
a base that serves as a seat for a user; and
a resistance mechanism with a first and second end, said resistance mechanism connected at its first end to said base, said resistance mechanism extendable linearly, providing resistance as it is extended, and capable of automatically retracting to its starting length; and
a flexible frame connected at one end to the second end of the resistance mechanism, said frame including at least two mounting hubs connected to said frame and with hub centers spaced one to four inches away from the frame's bending axis; and
rounded edged parts mounted to said hubs on each side of the hubs, said rounded edged parts extending away from the hubs and away from said frame's bending axis thereby creating a gap between the rounded edged parts and in front of the hubs thereby allowing the rounded edged parts to rest on each side of the user's spine and keeping the hubs from touching the user's spine; and
a handlebar frame connected to the flexible frame at the end opposite where the resistance mechanism connects to the flexible frame, said handlebars shaped to wrap around the back of the user's neck, rest on the shoulders, and including unobstructed space for hands to hold said handlebars.

2. The frame of claim one, wherein said frame is comprised of two to five mounting hub links connected to each other with fasteners that allow the frame to bend in one plane.

3. The frame of claim one, wherein said frame is a single piece comprised of two to five hub mounts permanently interconnected by thinner flexible frame sections.

4. The rounded edged parts of claim one, wherein said rounded edged parts are wheels, between two inches and five inches in diameter, that rotate on axles attached to or running through the mounting hubs of claim one.

5. The exercise device and rounded edged parts of claim one, wherein said rounded edged parts are smooth surfaced rounded-edge nubs fixed to and extending out and away from the mounting hubs of claim one, and capable of sliding along the skin or fabric worn by a user of the exercise device as it is used.

6. The resistance mechanism of claim one, wherein said resistance mechanism is comprised of two concentric and telescoping tubes with a spring or elastic member inside the tubes, said spring or elastic member connected on one end to the inner telescoping tube and on its other end to the outer telescoping tube.

7. The resistance mechanism of claim one, wherein said resistance mechanism is an extensible hydraulic actuator that provides resistance to being extended and a means for returning to its starting length without assistance.

8. The resistance mechanism of claim one, wherein said resistance mechanism is an extensible hydraulic actuator that provides an adjustable resistance to being extended and a means for returning to its starting length without assistance.

9. The resistance mechanism of claim one, wherein said resistance mechanism is an extensible pneumatic actuator that provides resistance to being extended and a means for returning to its starting length without assistance.

10. The resistance mechanism of claim one, wherein said resistance mechanism is an extensible pneumatic actuator that provides an adjustable resistance to being extended and a means for returning to its starting length without assistance.

11. The resistance mechanism of claim one, wherein said resistance mechanism includes posts extending from each of its ends and between which additional resistance bands can be positioned to provide additional resistance when said resistance mechanism is extended.

12. The exercise device of claim one, wherein the means for connecting said device's base and resistance mechanism is a bracket that allows said resistance mechanism to be connected to said bracket at a variable distance from said base.

13. The handlebars of claim one, wherein said handlebars are comprised of a rigid frame, two hand grips at each end of the rigid frame, with foam padding attached so it rests between the frame and the user's shoulders.

14. The handlebars and flexible frame of claim one, wherein the means for connecting said handlebars and flexible frame is a length adjustment link that allows the handlebars and flexible frame to be connected with a variable distance between them.
